(19) United States
(12) Patent Application Publication
(10) Pub. No.: US 2009/0175673 A1
(43) Pub. Date: Jul. 9, 2009

(54) BINDERS FOR HOLDING LAMINAR OBJECTS

(76) Inventors: Paul Elliott, Derbyshire (GB); David King, Derbyshire (GB); David Harbinson, Derbyshire (GB)

Correspondence Address: MORRISON & FOERSTER LLP, 755 PAGE MILL RD, PALO ALTO, CA, 94304-1018, US

(21) Appl. No.: 12/167,984

(22) Filed: Jul. 3, 2008

(30) Foreign Application Priority Data
Jul. 3, 2007 (GB) 0712858.0

(51) Int. Cl. B42F 13/40

(52) U.S. Cl. 402/4

(57) ABSTRACT

In the field of binders for laminar objects there is a need for a binder which is able to offer a distinctive and unusual appearance,

A binder (10), for holding laminar objects (46), comprises a support member (12) which includes at least one binder element (18; 50) to hold one or more laminar objects (46) via respective edges thereof. The support member (12) also includes first and second support elements (34, 36) which are couplable to one another to secure a cover body (25; 100) therebetween. The cover body (28; 100) includes first and second cover elements (14, 16) which extend from either side of the support member (12).

This invention relates to a binder for holding laminar objects.

Laminar objects such as photographs, drawings, paintings or cards are often held in a binder for storage purposes. The binder helps to protect the laminar objects and also provides a convenient way of viewing the objects when desired.

Conventional binders typically have a traditional appearance and are rather plain.

Increasingly consumers are looking for a more distinctive way of holding items such as photographs which offers a more interesting experience when viewing the items with friends and colleagues.

Therefore there is a need for a binder which is able to offer a more distinctive and unusual appearance.

According to the invention there is provided a binder, for holding laminar objects, comprising a support member including at least one binder element to hold one or more laminar objects via respective edges thereof and first and second support elements couplable to one another to clampingly secure a cover body therebetween, the cover body including integrally formed first and second cover elements, the cover elements extending from either side of the support member.

The provision of first and second support elements that are couplable to one another to clampingly secure the cover body therebetween obviates the need for any secondary fastening operations to secure the cover body and the support member to one another. As a result it is possible readily to vary the appearance of the cover body within a given manufacturing batch, and so allow for the production of binders having a wide variety of distinctive and unusual appearances.

A cover body having integrally formed first and second cover elements is readily manufacturable and assists in securing the cover elements to the support body, thereby further enabling the production of a wide range of distinctive and unusual binders.

Preferably at least one cover element includes a hollow pocket containing first and second visibly distinct fillers and at least one transparent portion through which the contents of the hollow pocket are visible.

The ability to view first and second visibly distinct fillers in at least one cover element imbues the binder with a distinctive an unusual appearance.

Providing each of the cover elements with a hollow pocket allows the binder to have an attractive and interesting appearance from front and rear sides.

Furthermore, the inclusion of first and second distinct fillers allows a user to modify the appearance of the binder, as desired, by displacing the fillers within the or each pocket.

Preferably the first and second fillers are immiscible liquids.

The inclusion of immiscible liquids allows a user readily to displace the fillers within the or each pocket, and so readily modify the appearance of the binder. In this way the binder is able to adopt a limitless range of differing appearances.

Optionally the or each hollow pocket further contains a third visibly distinct filler. The inclusion of a third visibly distinct filler provides for further variation and interest in the range of appearances of the binder.

In a preferred embodiment of the invention the third visibly distinct filler is or includes a gas. Such an arrangement provides for an attractive and interesting contrast between the fillers.

The colour of the fillers may differ from one another. This provides a readily discernable difference in the appearance of the fillers.

Optionally the cover body defines a hollow pocket extending across both cover elements. This arrangement imbues the whole of the cover body with an interesting and unusual appearance.

In a still further preferred embodiment of the invention the cover body defines at least one discrete hollow pocket in each cover element. The provision of discrete hollow pockets in each cover element provides the option of having different fillers in each pocket so as to further vary the appearance of the binder.

Optionally at least one cover element is opaque. The provision of one or more opaque cover elements allows the binder to have a distinctive appearance which is unaffected by the appearance of the or each laminar object held by the binder.

Preferably, the or each opaque cover element includes an opaque panel. Such an arrangement is readily manufacturable and minimises the need for secondary processing steps.

The or each opaque cover element may optionally include a hollow pocket containing a panel, at least one of the hollow pocket or the panel being opaque. This configuration permits the use of a low-cost panel to provide a desired degree of rigidity to the cover element while permitting the use of a more expensive, but more tactile, material for the pocket.

The cover body and the support member may include mutually co-operable formations to secure one to the other. Such features help to reduce the time required to assemble the binder by reducing the need for any subsequent fastening operations.

Optionally the cover body includes a support portion lying between the first and second cover elements, the support portion including one mutually co-perable formation. This arrangement further assists in simplifying assembly of the binder.

Optionally the support portion defines a hollow pocket.

Preferably, the opaque support portion includes an opaque panel.

The opaque support portion may optionally include a hollow pocket containing a panel wherein at least one of the hollow pocket or the panel is opaque.

The foregoing features share the advantages associated with the corresponding features of the cover elements.

In a further preferred embodiment of the invention the or each binder element protrudes from the support member and includes an enlarged portion extending along an exposed periphery thereof, the enlarged portion being engagable with a corresponding recess in a laminar object to hold the laminar object. Such features provide a convenient way of securing one or more laminar objects in the binder.

There now follows a brief description of a preferred embodiment of the invention, by way of non-limiting example, with reference to the accompanying drawings in which:

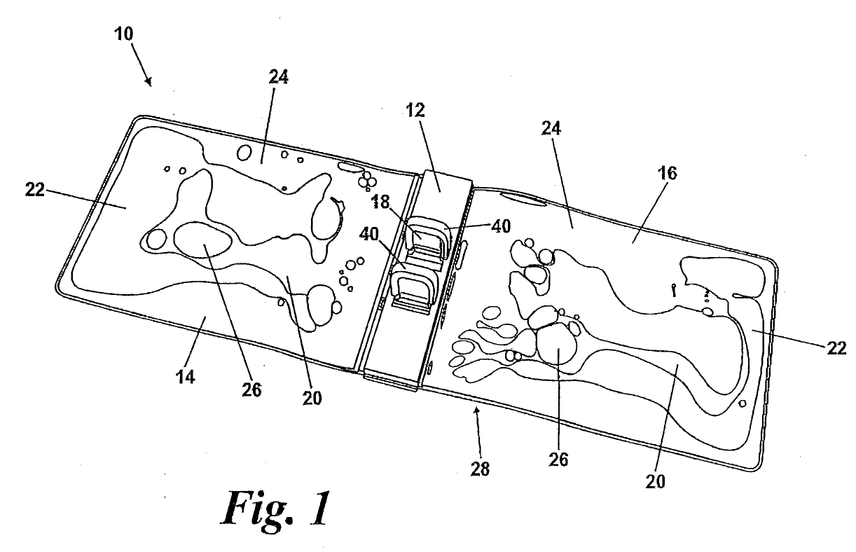

FIG. 1 shows a binder according to a first embodiment of the invention in a first configuration;

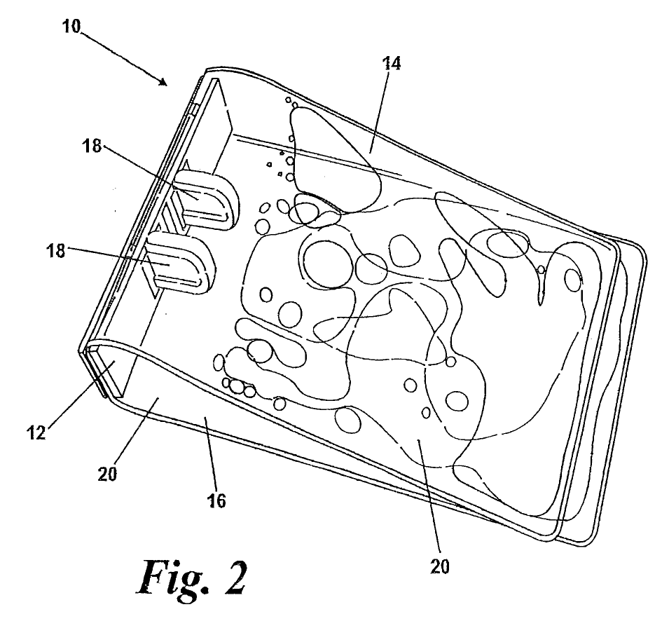

FIG. 2 shows the binder shown in FIG. 1 in a second configuration;

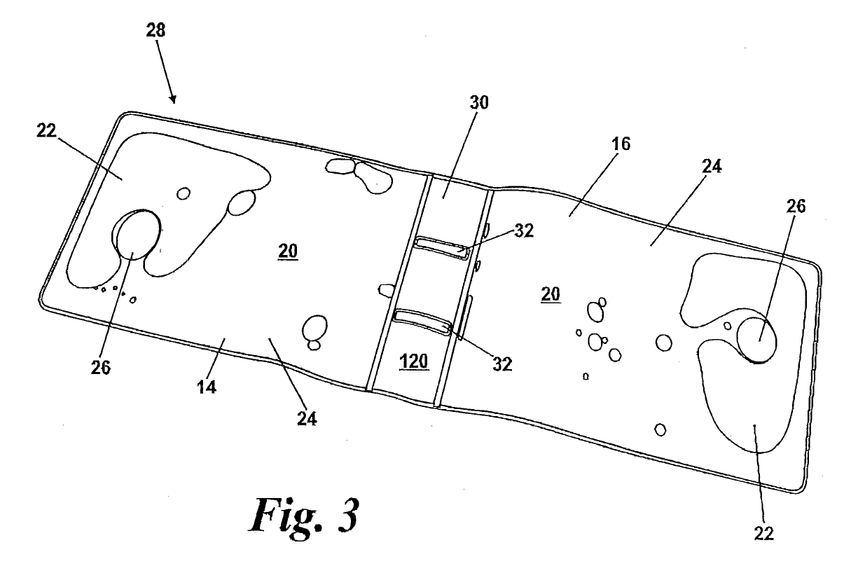

FIG. 3 shows a first cover body;

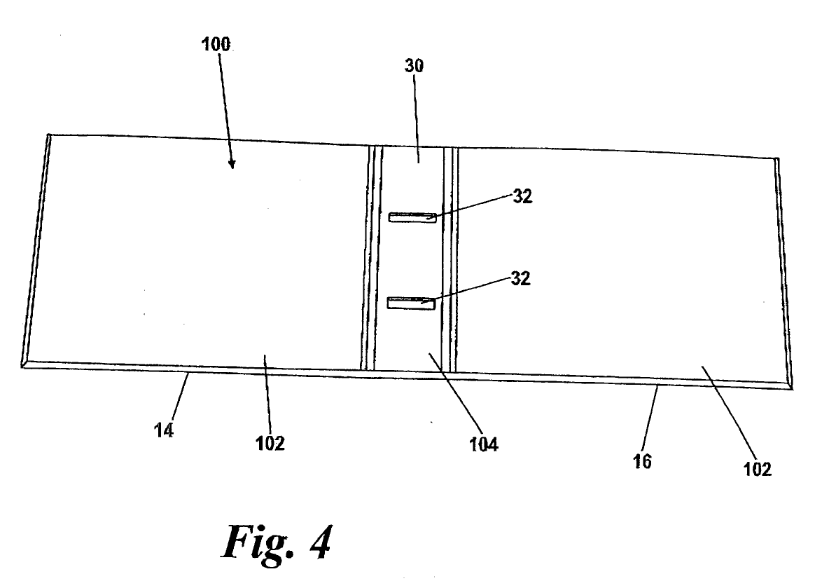

FIG. 4 shows a second cover body;

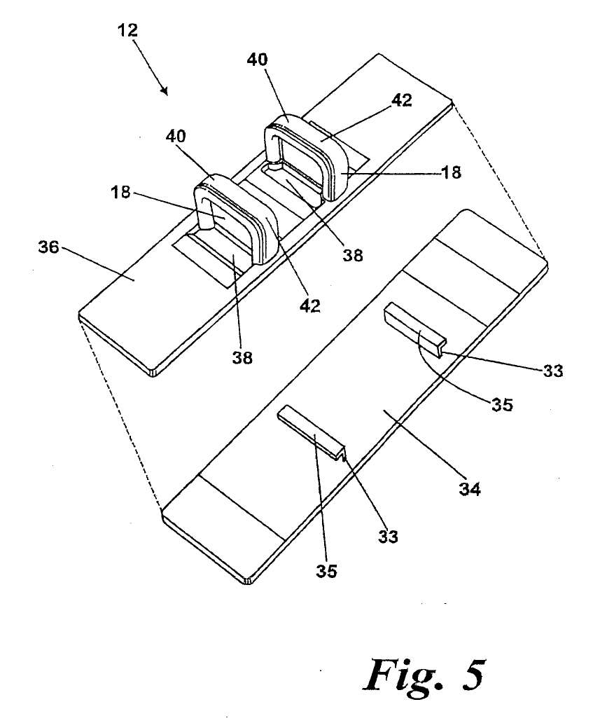

FIG. 5 shows an exploded view of a support member:

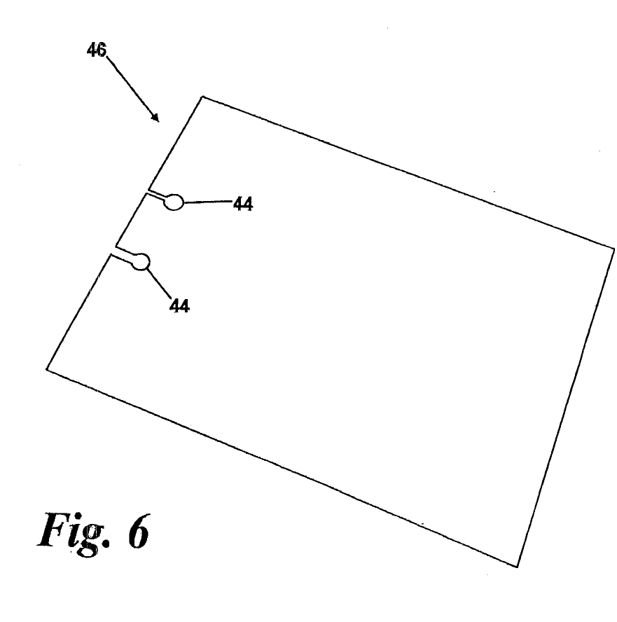

FIG. 6 shows a laminar object; and

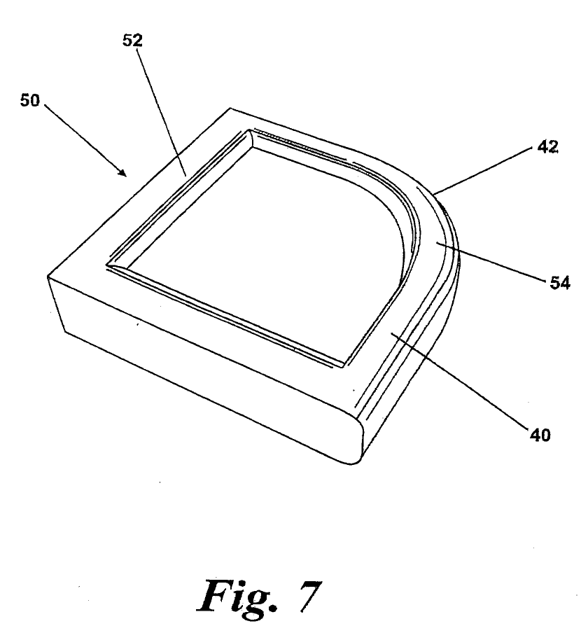

FIG. 7 shows a binder element according to another embodiment of the invention.

A binder according to a first embodiment of the invention is designated generally by the reference numeral 10.

The binder 10 includes a support member 12 and first and second cover elements 14, 16 that extend from either side of the support member 12.

The support member 12 shown includes two U-shaped binder elements 18 to hold one or more laminar objects (not shown) via respective edges thereof. Other embodiments of the invention may include more or less than two binder elements 18.

In the embodiment shown, each cover element 14, 16 is flexible and includes a hollow pocket 20 that contains first, second and third visibly distinct fillers 22, 24, 26. Other embodiments of the invention may include different numbers and configurations of the hollow pockets 20, such as a plurality of hollow pockets 20 in each cover element 14, 16, and differing numbers of visibly distinct fillers.

Each cover element 14, 16 in the embodiment shown is formed from a transparent material so that the contents of each hollow pocket 20 are visible from both sides of the respective cover element 14, 16. Other embodiments of the invention (not shown) may include, for example, a transparent window in one or both sides of a given cover element 14, 16 such that the contents of the hollow pocket 20 therein are visible.

In the embodiment shown, the first and second fillers 22, 24 are immiscible liquids, and the third filler 26 is a gas, and preferably air.

The colour of each filler 22, 24, 26 differs from one another.

As shown in FIG. 3, the first and second cover elements 14, 16 are integrally formed from a cover body 28.

The cover body 28 defines a hollow pocket 20 in each of the first and second cover elements 14, 16. Each pocket 20 contains the first, second and third visibly distinct fillers 22, 24, 26.

In another embodiment of the invention (not shown), the cover body may define a hollow pocket that extends across both the first and second cover elements.

Other embodiments of the invention may also have pockets that include a different number and combination of visibly distinct fillers.

Referring again to FIG. 3, the cover body 28 includes a support portion 30 lying between a discrete hollow pocket 20 in each of the first and second cover elements 14, 16.

The support portion 30 includes a hollow pocket 120 and includes two apertures 32 which correspond in position to a pair of engagement members 33 on the support member 12. The apertures 32 and engagement members 33 cooperate with one another to secure the cover body 28 and the support body 12 to one another.

FIG. 4 shows a further cover body 100 in which first and second cover elements 14, 16 are integrally formed.

Each of the first and second cover elements 14, 16 includes a hollow pocket 102 which contains a panel that, preferably, is rigid. In the embodiment shown both the hollow pockets 102 are opaque.

In other embodiments (not shown) one or more hollow pockets may be transparent, and the panel may be transparent or opaque.

In still further embodiments (not shown) each of the opaque cover elements may be formed from an opaque panel.

The second cover body 100 also includes an opaque support portion 30 which lies between the cover elements 14, 16.

The support portion 30 includes an opaque hollow pocket 104 that contains a corresponding panel that, preferably, is rigid.

In other embodiments (not shown) the support portion 30 may be transparent, and the corresponding panel may be transparent or opaque.

In further embodiments (not shown) each of the opaque cover elements may be formed from an opaque panel.

Each of the cover bodies 28; 100 is functionally interchangeable with the other.

As shown in FIG. 5, the support member 12 includes first and second support elements 34, 36 which are couplable to one another, via the pair of engagement members 33 which extend from the first support element 34 and a pair of corresponding receiving apertures 38 in the second support element 36, to clampingly secure the cover body 28 between the first and second support elements 34, 36. Each engagement member 33 includes a barb 35 to allow insertion into the corresponding receiving aperture 38 and inhibit subsequent removal.

In other arrangements, not shown, the first support element 34 may be coupled directly with the cover body 28; 100 by, for example, one or more rivets, nuts and bolts, or other fastener.

Each binder element 18 protrudes from the second support element 36 and includes an enlarged portion 40 which extends along an exposed periphery 42 thereof.

The enlarged portion 40 of each binder element 18 is engagable with a corresponding recess 44 in a laminar object 46, as shown in FIG. 6, to hold the laminar object 46 in the binder 10.

In use, a user is able to add or remove laminar objects 46 to/from the binder 10 by selectively engaging or disengaging the enlarged portion 40 of the binder elements 18 and the corresponding recesses 44 in the laminar object 46,

The user is able to move the binder 10 between an open configuration, as shown in FIG. 1, and a closed configuration, as shown in FIG. 2, to facilitate viewing or storage of the laminar objects, as desired.

In addition, the user is able to displace the visibly distinct fillers 22, 24, 26 in each of the hollow pockets 20 in order to vary the appearance of each cover element 14, 16, and hence the overall appearance of the binder 10.

FIG. 7 shows a binder element 50 according to another embodiment of the invention. The second binder element 50 includes an enlarged portion 40 which extends along an exposed periphery 42 thereof.

The enlarged portion 40 includes a first, straight portion 62 and a second, curved portion 54.

In use, the first, straight portion 62 lies adjacent to a first cover element 14 (as depicted in FIG. 1), and the second, curved portion 54 lies adjacent to a second cover element 16.

The second, curved portion 54 assists a user in moving a plurality of laminar objects overlying the second cover element 16 so as to overlie the first cover element 14 during, for example, viewing the laminar objects. While lying over the first cover element 14 the laminar objects are held by the first, straight portion 52 of the binder element 50. This helps to keep the laminar objects aligned with one another and the cover elements 14, 16.

1. A binder, for holding laminar objects, comprising a support member including at least one binder element to hold one or more laminar objects via respective edges thereof and first and second support elements couplable to one another to clampingly secure a cover body therebetween, the cover body including integrally formed first and second cover elements, the cover elements extending from either side of the support member.

2. A binder according to claim 1 wherein at least one cover element includes a hollow pocket containing first and second visibly distinct fillers and at least one transparent portion through which the contents of the hollow pocket are visible.

3. A binder according to claim 2 wherein the first and second fillers are immiscible liquids.

4. A binder according to claim 2 wherein each hollow pocket further contains a third visibly distinct filler.

5. A binder according to claim 4 wherein the third visibly distinct filler is or includes a gas.

6. A binder according to claim 2 wherein the colour of the fillers differs from one another.

7. A binder according to claim 2 wherein the cover body defines a hollow pocket extending across both cover elements.

8. A binder according to claim 2 wherein the cover body defines at least one discrete hollow pocket in each cover element.

9. A binder according to claim 1 wherein at least one cover element is opaque.

10. A binder according to claim 9 wherein each opaque cover element includes an opaque panel.

11. A binder according to claim 9 wherein each opaque cover element includes a hollow pocket containing a panel, at least one of the hollow pocket or the panel being opaque.

12. A binder according to claim 1 wherein the cover body and the support member include mutually co-operable formations to secure one to the other.

13. A binder according to claim 12 wherein the cover body includes a support portion lying between the first and second cover elements, the support portion including one mutually co-operable formation.

14. A binder according to claim 13 wherein the support portion defines a hollow pocket.

15. A binder according to claim 13 wherein the support portion is opaque.

16. A binder according to claim 15 wherein the opaque support portion is an opaque panel.

17. A binder according to claim 15 wherein the opaque support portion includes a hollow pocket containing a panel, at least one of the hollow pocket or the panel being opaque.

18. A binder according to claim 1 wherein the or each binder element protrudes from the support member and includes an enlarged portion extending along an exposed periphery thereof, the enlarged portion being engagable with a corresponding recess in a laminar object to hold the laminar object.
